(19) United States
(12) Patent Application Publication
(10) Pub. No.: US 2026/0338380 A1
(43) Pub. Date: Oct. 29, 2026

(54) SUPPORT DEVICE AND METHOD FOR MANUFACTURING SUPPORT DEVICE

(71) Applicant: MITSUBISHI HEAVY INDUSTRIES, LTD., Tokyo (JP)

(72) Inventor: Shinya HASHIMOTO, Tokyo (JP)

(21) Appl. No.: 19/120,409

(22) PCT Filed: Oct. 25, 2023
(86) PCT No.: PCT/JP2023/038449

§ 371 Date: Apr. 11, 2025

(30) Foreign Application Priority Data
Nov. 7, 2022 (JP) 2022-178109

(51) Int. Cl. F23R 3/60; F16F 1/02

(52) U.S. Cl. CPC F23R 3/60; F16F 1/025

(57) ABSTRACT

A support device including: at least one first strut having a first proximal end to be connected to a first wall and a first distal end, and extends from the first proximal end to the first distal end toward a second wall; at least one second strut having a second proximal end to be connected to the second wall and a second distal end, and extends from the second proximal end to the second distal end toward the first wall through the first distal end; and a connecting portion that has at least one third strut extending along the extension direction of the first strut and the second strut in a position range between the first distal end and the second distal end in the extension direction, and connects the first distal end of the first strut and the second distal end of the second strut.

### TECHNICAL FIELD

The present disclosure relates to a support device and a method for manufacturing the support device.

The present application claims the right of priority based on Japanese Patent Application No. 2022-178109 filed with the Japan Patent Office on Nov. 7, 2022, the content of which is incorporated herein by reference.

### BACKGROUND ART

A support device that supports a first member and a second member with respect to one another while allowing relative movement between the first member and the second member is known.

For example, the device disclosed in PTL 1 is configured to support a float while allowing relative movement between a transverse bulkhead and the float.

### CITATION LIST

### Patent Literature

[PTL 1] Japanese Unexamined Patent Application Publication No. 2008-151695

### SUMMARY OF INVENTION

### Technical Problem

However, for example, in a combustor of an industrial gas turbine, it is desirable that a pipe or the like disposed along a side surface of a combustion cylinder, such as a pipe for allowing steam for cooling to flow, for example, is supported by the combustion cylinder. In a case where these pipes are mounted on the combustion cylinder via a support device, the support device is required to have a structure capable of absorbing thermal elongation of these pipes or the combustion cylinder.

However, in a case where the support structure of the float described in the patent literature described above is adopted as the support device in this case, it is difficult to configure the support device to ensure the required support strength in a limited space of a side portion of the combustion cylinder while making it possible to absorb the thermal elongation described above.

In view of the above circumstances, an object of at least one embodiment of the present disclosure is to provide a support device that supports a first member and a second member with respect to one another while allowing relative movement between the first member and the second member.

### Solution to Problem

(1) A support device according to at least one embodiment of the present disclosure is a support device for supporting a second member having a second wall facing a first wall with respect to a first member having the first wall, the support device including:
at least one first strut that has a first base end portion which is connected to the first wall, and a first tip portion which is an end portion on a side opposite to the first base end portion, and that extends toward the second wall from the first base end portion to the first tip portion;
at least one second strut that has a second base end portion which is connected to the second wall, and a second tip portion which is an end portion on a side opposite to the second base end portion and which is located closer to the first wall with respect to the first tip portion, and that extends toward the first wall by passing through the first tip portion from the second base end portion to the second tip portion; and
a connection portion that has at least one third strut extending along an extension direction of each of the first strut and the second strut in a position range between the first tip portion and the second tip portion in the extension direction, and that connects the first tip portion of the first strut and the second tip portion of the second strut.

(2) A method for manufacturing a support device according to at least one embodiment of the present disclosure is a method for manufacturing a support device for supporting a second member having a second wall facing a first wall with respect to a first member having the first wall, the method including:
integrally molding, by additive manufacturing,
at least one first strut that has a first base end portion which is connected to the first wall, and a first tip portion which is an end portion on a side opposite to the first base end portion, and that extends toward the second wall from the first base end portion to the first tip portion;
at least one second strut that has a second base end portion which is connected to the second wall, and a second tip portion which is an end portion on a side opposite to the second base end portion and which is located closer to the first wall with respect to the first tip portion, and that extends toward the first wall by passing through the first tip portion from the second base end portion to the second tip portion; and
a connection portion that has at least one third strut extending along an extension direction of each of the first strut and the second strut in a position range between the first tip portion and the second tip portion in the extension direction, and that connects the first tip portion of the first strut and the second tip portion of the second strut.

Advantageous Effects of Invention According to at least one embodiment of the present disclosure, it is possible to provide a support device that supports a first member and a second member with respect to one another while allowing relative movement between the first member and the second member.

### BRIEF DESCRIPTION OF DRAWINGS

FIG. 1 is a schematic configuration diagram of a gas turbine according to an embodiment.

FIG. 2 is a schematic diagram showing a combustor and an inlet portion of a turbine of the gas turbine according to the embodiment.

FIG. 3A is a perspective partial sectional view of a support device according to an embodiment.

FIG. 3B is a perspective partial sectional view of a support device according to another embodiment.

FIG. 4A is a schematic sectional view for describing an example of a structure of a support device according to some embodiments.

FIG. 4B is a schematic sectional view for describing another example of the structure of the support device according to some embodiments.

FIG. 4C is a schematic sectional view for describing another example of the structure of the support device according to some embodiments.

FIG. 4D is a schematic sectional view for describing another example of the structure of the support device according to some embodiments.

FIG. 5A is a sectional view taken along line A-A of FIG. 4A and viewed from a direction of an arrow.

FIG. 5B is a sectional view taken along line B-B of FIG. 4B and viewed from a direction of an arrow.

FIG. 5C is a sectional view taken along line C-C of FIG. 4B and viewed from a direction of an arrow.

### DESCRIPTION OF EMBODIMENTS

Hereinafter, some embodiments of the present disclosure will be described with reference to the accompanying drawings. Dimensions, materials, shapes, relative arrangements, and the like of components described as embodiments or illustrated in the drawings are not intended to limit the scope of the present disclosure, but are merely explanatory examples.

For example, an expression indicating a relative arrangement or an absolute arrangement, such as “in a direction”, “along a direction”, “parallel”, “orthogonal”, “center”, “concentric”, or “coaxial”, not only strictly represents such a disposition, but also represents a state of being relatively displaced with a tolerance, or an angle or a distance to the extent that the same function can be obtained.

For example, expressions such as “identical”, “equal”, and “homogeneous”, which indicate that things are in the same state, not only represent a state of being strictly equal, but also represent a state in which there is a tolerance, or a difference to the extent that the same function can be obtained.

For example, an expression indicating a shape such as a square shape or a cylindrical shape not only represents a shape such as a square shape or a cylindrical shape in a geometrically strict sense, but also represents a shape that includes concave and convex portions, chamfered portions, or the like to the extent that the same effects can be obtained.

Meanwhile, an expression such as “comprising”, “possessing”, “provided with”, “including”, or “having” one component is not an exclusive expression excluding the presence of other components.

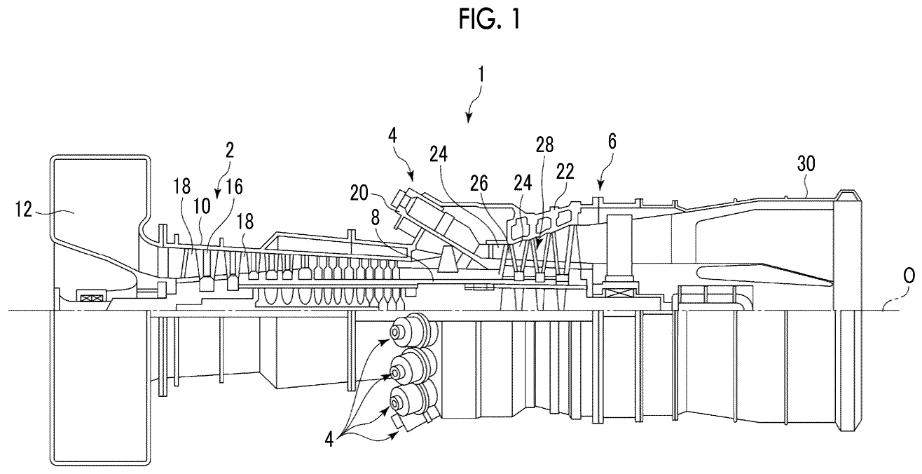

First, a gas turbine, which is an example of an application target of a support device according to an embodiment, will be described with reference to FIG. 1. FIG. 1 is a schematic configuration diagram of the gas turbine according to an embodiment.

As shown in FIG. 1, a gas turbine 1 includes a compressor 2 for generating compressed air, a combustor 4 for generating a combustion gas using the compressed air and fuel, and a turbine 6 configured to be rotationally driven by the combustion gas. In the case of the gas turbine 1 for power generation, a generator (not shown) is connected to the turbine 6.

The compressor 2 includes a plurality of stator vanes 16 fixed to a side of a compressor casing 10, and a plurality of rotor blades 18 embedded in a rotor 8 to be alternately arranged with respect to the stator vanes 16.

Air taken in from an air intake port 12 is sent to the compressor 2, and the air passes through the plurality of stator vanes 16 and the plurality of rotor blades 18 and is compressed to become high-temperature and high-pressure compressed air.

The fuel and the compressed air generated by the compressor 2 are supplied to the combustor 4, and the fuel is combusted in the combustor 4, so that a combustion gas serving as a working fluid of the turbine 6 is generated. As shown in FIG. 1, the gas turbine 1 includes a plurality of combustors 4 disposed along a circumferential direction centered on the rotor 8 in a casing 20.

The turbine 6 includes a combustion gas passage 28 formed by a turbine casing 22, and includes a plurality of stator vanes 24 and a plurality of rotor blades 26 provided in the combustion gas passage 28. The stator vanes 24 and the rotor blades 26 of the turbine 6 are provided on a downstream side of the combustor 4 with respect to a flow of the combustion gas.

The stator vane 24 is fixed to a side of the turbine casing 22, and a stator vane row is configured with the plurality of stator vanes 24 arranged along the circumferential direction of the rotor 8. Further, the rotor blades 26 are embedded on the rotor 8, and a rotor blade row is configured with the plurality of rotor blades 26 arranged along the circumferential direction of the rotor 8. The stator vane row and the rotor blade row are alternately arranged in an axial direction of the rotor 8.

In the turbine 6, the combustion gas from the combustor 4 that flows into the combustion gas passage 28 passes through the plurality of stator vanes 24 and the plurality of rotor blades 26, so that the rotor 8 is rotationally driven around an axis line O. As a result, a generator connected to the rotor 8 is driven to generate power. After driving the turbine 6, the combustion gas is discharged to an outside via an exhaust chamber 30.

### Combustor 4

Next, the combustor 4 according to the embodiment will be described.

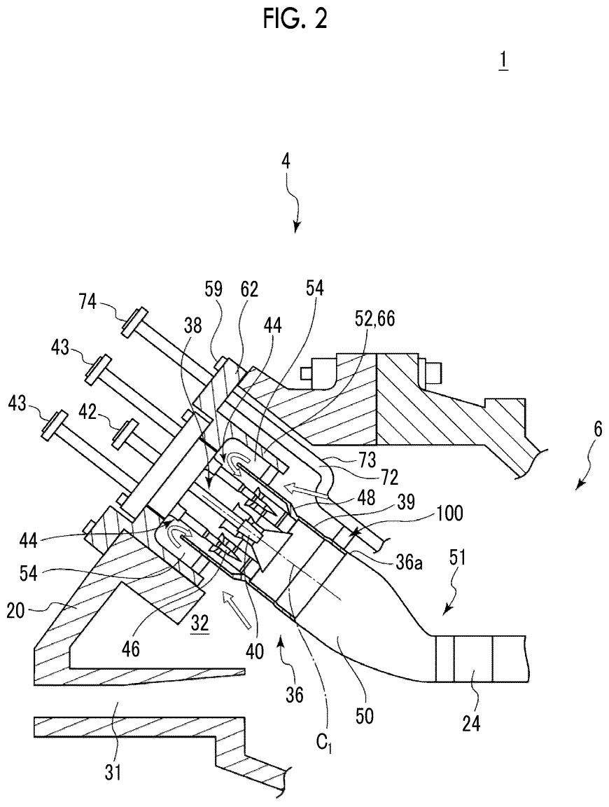

FIG. 2 is a schematic diagram showing the combustor 4 and an inlet portion of the turbine 6 of the gas turbine 1 according to the embodiment.

In the gas turbine 1 according to some embodiments, each of the plurality of combustors 4 (refer to FIG. 1) that are disposed in the circumferential direction centered on the rotor 8 includes a combustion cylinder (combustion liner) 36 provided in a combustor casing 32 defined by the casing 20, a first combustion burner 38 disposed in the combustion cylinder 36, and a plurality of second combustion burners 44 disposed to surround the first combustion burner 38. That is, the combustion cylinder 36, the first combustion burner 38, and the second combustion burner 44 are accommodated in the casing 20.

The combustion cylinder (combustion liner) 36 has an inner cylinder 48 disposed around the first combustion burner 38 and the plurality of second combustion burners 44, and a transition piece 50 connected to a tip portion of the inner cylinder 48. The inner cylinder 48 and the transition piece 50 may be integrally formed.

The first combustion burner 38 is disposed along a direction of a central axis Ci of the combustion cylinder 36 (that is, an axial direction of the combustor 4), and has a first fuel nozzle 40 for injecting fuel. Fuel is supplied to the first fuel nozzle 40 via a first fuel port 42.

The second combustion burner 44 has a second fuel nozzle 46 for injecting fuel. Fuel is supplied to the second fuel nozzle 46 via a second fuel port 43.

The combustor 4 further includes an outer cylinder 52 provided on an outer periphery side of the inner cylinder 48 inside the casing 20. An air passage 54 through which the compressed air flows is formed on an outer periphery side of the inner cylinder 48 and an inner periphery side of the outer cylinder 52.

The compressed air generated by the compressor 2 (refer to FIG. 1) is supplied into the combustor casing 32 via a casing inlet 31, and the compressed air flows into the air passage 54 from the combustor casing 32 as combustion air, is turned in direction by a wall surface portion 53 provided along a surface orthogonal to the axial direction of the combustor 4, and flows into the burner cylinder of each of the combustion burners 38 and 44. Then, in each burner cylinder, the fuel injected from the fuel nozzle and the compressed air (combustion air) are mixed, and the mixed gas flows into the combustion cylinder 36 and is ignited and combusted, so that the combustion gas is generated.

The first combustion burner 38 described above may be a burner for generating a diffusion combustion flame, and the second combustion burner 44 may be a burner for combusting premixed gas to generate a premixed combustion flame.

In this way, the combustion gas generated by the combustion of the fuel in the combustor 4 flows into the turbine 6 via an outlet portion 51 of the combustor 4 located at a downstream end portion of the transition piece 50.

The combustor 4 may include other components such as a bypass pipe (not shown) for bypassing the combustion gas.

### Regarding Support Device 100

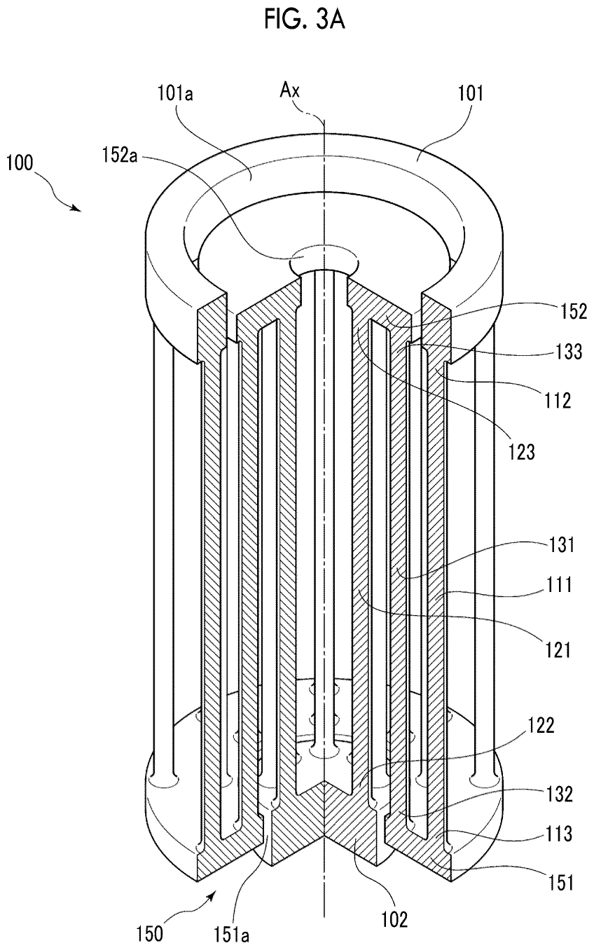

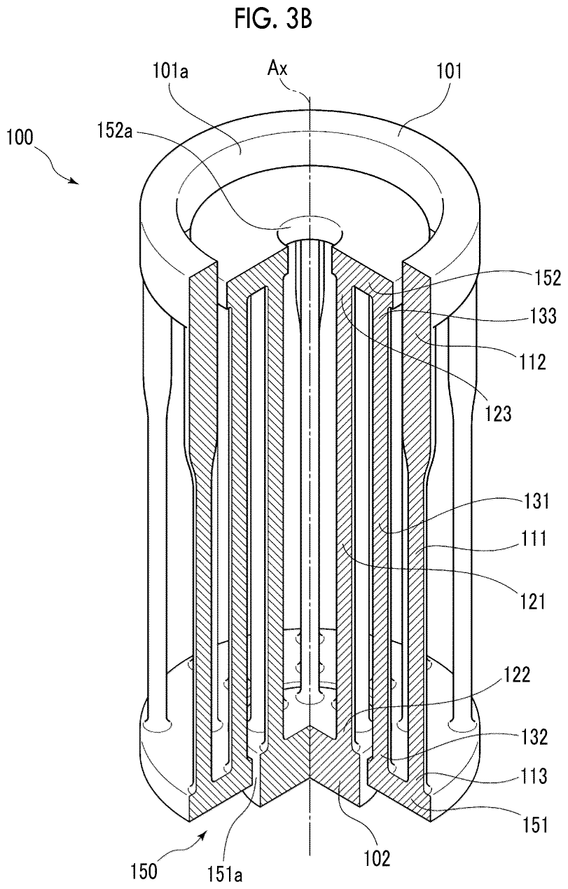

FIG. 3A is a perspective partial sectional view of a support device 100 according to the embodiment.

FIG. 3B is a perspective partial sectional view of the support device 100 according to another embodiment.

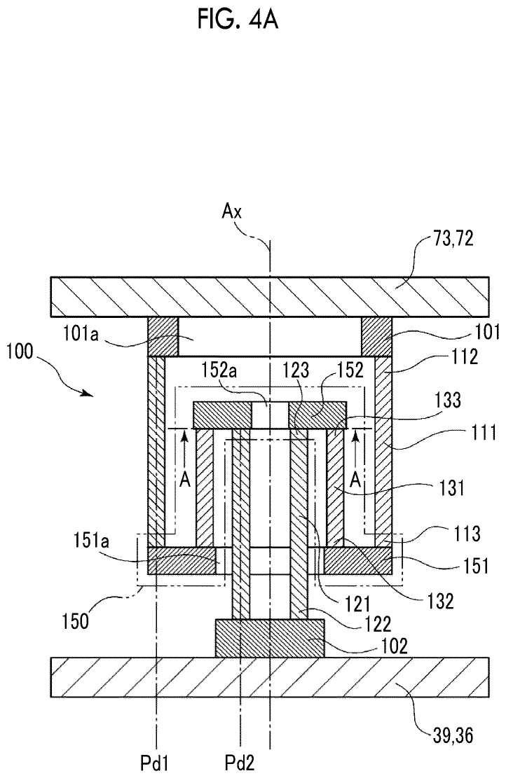

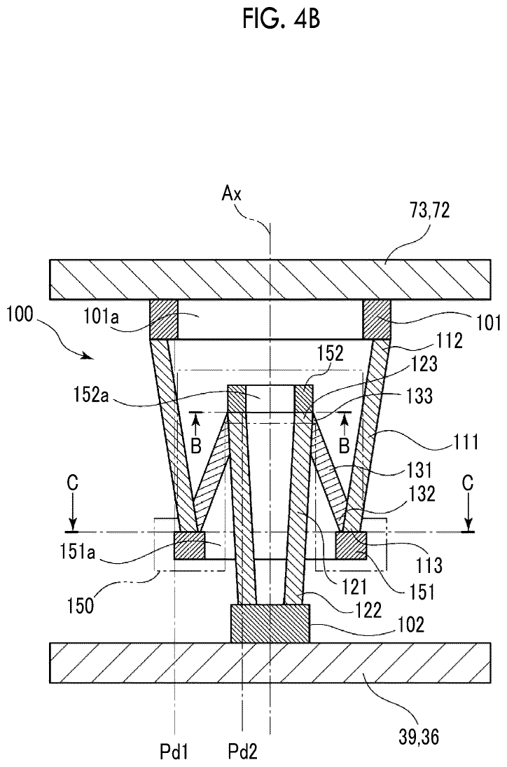

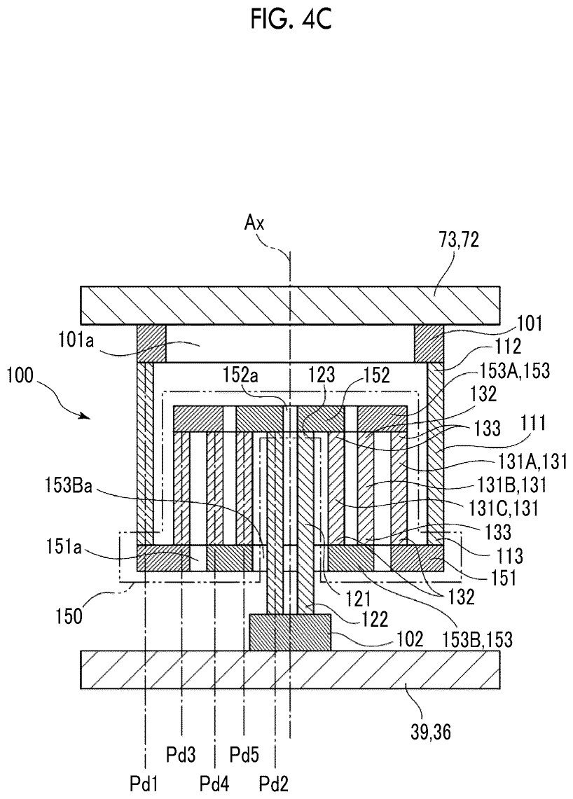

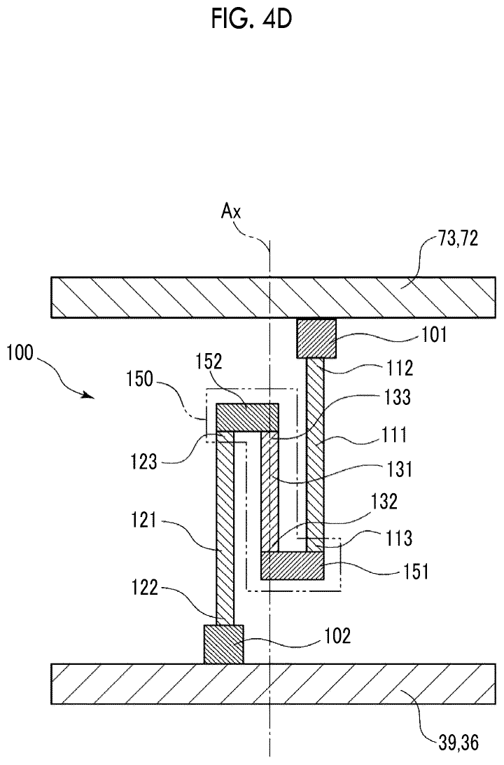

FIG. 4A is a schematic sectional view for describing an example of the structure of the support device 100 according to some embodiments.

FIG. 4B is a schematic sectional view for describing another example of the structure of the support device 100 according to some embodiments.

FIG. 4C is a schematic sectional view for describing another example of the structure of the support device 100 according to some embodiments.

FIG. 4D is a schematic sectional view for describing another example of the structure of the support device 100 according to some embodiments.

The support device 100 according to some embodiments is a support device 100 for supporting a second member having a second wall facing a first wall with respect to a first member having the first wall.

The support device 100 according to some embodiments is a support device that supports a steam pipe 72 as the first member and the combustion cylinder 36 as the second member with respect to one another while allowing relative movement between the steam pipe 72 and the combustion cylinder 36. The steam pipe 72 is, for example, a pipe through which steam for cooling the combustor 4 flows. The steam for cooling is supplied to the steam pipe 72 via a steam port 74.

The support device 100 according to some embodiments includes at least one first strut 111, at least one second strut 121, and a connection portion 150.

### First Strut 111

In the support device 100 according to some embodiments, the first strut 111 has a first base end portion 112 which is connected to a pipe wall 73 of the steam pipe 72 as the first wall, and a first tip portion 113 which is an end portion on a side opposite to the first base end portion 112, and is a columnar or rod-like member extending toward a cylindrical body 39 as the second wall from the first base end portion 112 to the first tip portion 113.

In the support devices 100 shown in FIGS. 3A and 3B, for example, eight first struts 111 are disposed at intervals in the circumferential direction centered on a central axis Ax of the support device 100.

### First End Portion Plate 101

As shown in FIGS. 3A, 3B, 4A, 4B, 4C, and 4D, in the support device 100 according to some embodiments, the first base end portion 112 is connected to the pipe wall 73 as the first wall via a first end portion plate 101.

The first end portion plate 101 is, for example, an annular member having an opening 101a. In the support device 100 according to some embodiments, the first end portion plate 101 is provided, so that the support device 100 is easily connected to the pipe wall 73 as compared with a case where each of the first base end portions 112 of the plurality of first struts 111 is directly connected to the pipe wall 73.

In the support device 100 according to some embodiments, the first base end portion 112 may be directly connected to the pipe wall 73 without the first end portion plate 101.

### Second Strut 121

In the support device 100 according to some embodiments, the second strut 121 is a columnar or rod-like member that has a second base end portion 122 which is connected to the cylindrical body 39 as the second wall, and a second tip portion 123 that is an end portion on a side opposite to the second base end portion 122 and that is located closer to the pipe wall 73 as the first wall with respect to the first tip portion 113, and that extends toward the pipe wall 73 as the first wall by passing through the first tip portion 113 from the second base end portion 122 to the second tip portion 123. In the support devices 100 shown in FIGS. 3A and 3B, for example, eight second struts 121 are disposed at intervals in the circumferential direction centered on the central axis Ax of the support device 100.

### Second End Portion Plate 102

As shown in FIGS. 3A, 3B, 4A, 4B, 4C, and 4D, in the support device 100 according to some embodiments, the second base end portion 122 is connected to the cylindrical body 39 as the second wall via a second end portion plate 102.

The second end portion plate 102 is, for example, a disk-shaped member, but may have an opening as in the first end portion plate 101. In the support device 100 according to some embodiments, the second end portion plate 102 is provided, so that the support device 100 is easily connected to the cylindrical body 39 as compared with a case where each of the second base end portions 122 of the plurality of second struts 121 is directly connected to the cylindrical body 39.

In the support device 100 according to some embodiments, the second base end portion 122 may be directly connected to the cylindrical body 39 without the second end portion plate 102.

### Connection Portion 150

In the support device 100 according to some embodiments, the connection portion 150 has at least one third strut 131 that extends in an extension direction of each of the first strut 111 and the second strut 121 in a position range between the first tip portion 113 and the second tip portion 123 in the extension direction, and is configured to connect the first tip portion 113 of the first strut 111 and the second tip portion 123 of the second strut 121.

In the support devices 100 shown in FIGS. 3A and 3B, for example, eight third struts 131 are disposed at intervals in the circumferential direction centered on the central axis Ax of the support device 100.

As described above, in the support device 100 according to some embodiments, the first strut 111 and the second strut 121 are connected in series in a zigzag shape via the connection portion 150. That is, in the support device 100 according to some embodiments, the first strut 111, the connection portion 150, and the second strut 121 are connected in series in a zigzag shape.

According to the support device 100 according to some embodiments having the structure described above, the first strut 111 and the second strut 121 are bent in a direction intersecting the extension direction, so that the support device can support the members (the steam pipe 72 and the combustion cylinder 36) with respect to one another while allowing a change in the relative position between the steam pipe 72 and the combustion cylinder 36 in the direction intersecting the extension direction. That is, according to the support device 100 according to some embodiments having the structure described above, it is possible to absorb the displacement between the steam pipe 72 as the first member and the combustion cylinder 36 as the second member in the direction intersecting the extension direction while ensuring the support strength for supporting the members with respect to one another.

The support device 100 according to some embodiments may be attached to the steam pipe 72 and the combustion cylinder 36 in the postures shown in FIGS. 3A, 3B, 4A, 4B, 4C, and 4D, or may be attached to the steam pipe 72 and the combustion cylinder 36 in postures in which the postures shown in FIGS. 3A, 3B, 4A, 4B, 4C, and 4D are reversed in an up-down direction of the drawing.

As shown in FIGS. 3A, 3B, 4A, 4B, and 4C, the support device 100 according to some embodiments may include a plurality of first struts 111. In the support device 100 according to some embodiments, the number of first struts 111 may be three or more.

Similarly, as shown in FIGS. 3A, 3B, 4A, 4B, and 4C, the support device 100 according to some embodiments may include a plurality of second struts 121. In the support device 100 according to some embodiments, the number of second struts 121 may be three or more.

As shown in FIGS. 3A, 3B, 4A, 4B, and 4C, in the support device 100 according to some embodiments, the plurality of first struts 111, the plurality of second struts 121, and the plurality of third struts 131 may be arranged in groups of three or more in the circumferential direction centered on the central axis Ax along the extension direction.

In this way, the rigidity of the support device 100 when the steam pipe 72 and the combustion cylinder 36 are displaced in a lateral direction can be prevented from decreasing in a specific direction in the lateral direction.

### Regarding Minimum Configuration of Support Device 100

As shown in FIG. 4D, the support device 100 according to some embodiments may include one first strut 111, one second strut 121, and the connection portion 150 having one third strut 131, as a minimum configuration.

In the support device 100 shown in FIG. 4D, the third strut 131 of the connection portion 150 has one end 132 that is connected to the first tip portion 113, and the other end 133 that is connected to the second tip portion 123 at a position closer to the pipe wall 73 as the first wall with respect to one end 132.

The first tip portion 113 and one end 132 of the third strut 131 may be connected to each other via a first connection portion 151 for connecting the first tip portion 113 and one end 132 of the third strut 131, as shown in FIG. 4D, or may be directly connected to each other without the first connection portion 151.

Similarly, the second tip portion 123 and the other end 133 of the third strut 131 may be connected to each other via a second connection portion 152 for connecting the second tip portion 123 and the other end 133 of the third strut 131, as shown in FIG. 4D, or may be directly connected to each other without the second connection portion 152.

In the support devices 100 shown in FIGS. 3A, 3B, 4A, 4B, and 4C, similarly to the support device 100 shown in FIG. 4D, the third strut 131 of the connection portion 150 has one end 132 that is connected to the first tip portion 113, and the other end 133 that is connected to the second tip portion 123 at a position closer to the pipe wall 73 as the first wall with respect to the one end 132.

In this way, the displacement in the lateral direction, that is, the direction intersecting the extension direction of the first strut 111 and the second strut 121, between the steam pipe 72 and the combustion cylinder 36 can be absorbed with a relatively simple configuration. In addition, in the support devices 100 shown in FIGS. 3A, 3B, 4A, 4B, 4C, and 4D, since one end 132 and the other end 133, which are both end portions of the third strut 131, are connected to the first tip portion 113 of the first strut 111 and the second tip portion 123 of the second strut 121, the sizes of these connection portions can be reduced to reduce the weight. In this way, since the natural frequency of the support device 100 itself can be increased, it is possible to avoid resonance and prevent the support device 100 from being damaged or malfunctioning.

In the support devices 100 shown in FIGS. 3A, 3B, 4A, 4B, and 4C, the connection portion 150 includes a plurality of third struts 131.

In this way, since the first strut 111, the third strut 131, and the second strut 121 are connected in a zigzag shape, even in a case where the distance between the steam pipe 72 and the combustion cylinder 36 is short, the displacement in a longitudinal direction, that is, the extension direction, between the steam pipe 72 and the combustion cylinder 36 can be suppressed while allowing the displacement in the lateral direction between the steam pipe 72 and the combustion cylinder 36.

In the support device 100 according to some embodiments, in a case where the support device 100 includes two or more first struts 111, the first struts 111 may be disposed at intervals in the circumferential direction centered on the central axis Ax of the support device 100.

Similarly, in the support device 100 according to some embodiments, in a case where the support device 100 includes two or more second struts 121, the second struts 121 may be disposed at intervals in the circumferential direction centered on the central axis Ax of the support device 100.

### Regarding Radial Position of Each Strut

In the support devices 100 shown in FIGS. 3A, 3B, 4A, 4B, and 4C, the connection portion 150 includes the first connection portion 151 to which the first tip portions 113 of the plurality of first struts 111 arranged in the circumferential direction at a first radial position Pd1 around the central axis Ax along the extension direction are connected, and the second connection portion 152 to which the second tip portions 123 of the plurality of second struts 121 arranged in the circumferential direction at a second radial position Pd2 on an inner side with respect to the first radial position Pd1 are connected. The first connection portion 151 is connected to the second connection portion 152 via the third strut 131.

As will be described later, in a case where the first strut 111 or the second strut 121 is inclined with respect to the central axis Ax, as in the support device 100 shown in FIG. 4B, a radial position with respect to the position of ½of the length of the first strut 111 or the second strut 121 along the extension direction is set as the first radial position Pd1 or the second radial position Pd2.

That is, in the support devices 100 shown in FIGS. 3A, 3B, 4A, 4B, and 4C, each of the second struts 121 is disposed on a radial inner side with the central axis Ax as a center with respect to each of the first struts 111.

In the support devices 100 shown in FIGS. 3A, 3B, 4A, and 4B, the first connection portion 151 and the second connection portion 152 are connected to each other by a plurality of third struts 131 that are disposed at intervals in the circumferential direction centered on the central axis Ax. That is, in the support devices 100 shown in FIGS. 3A, 3B, 4A, and 4B, one end 132 of each of the plurality of third struts 131 disposed in parallel is connected to the first connection portion 151, and the other end 133 of each of the plurality of third struts 131 disposed in parallel is connected to the second connection portion 152.

In the support device 100 shown in FIG. 4C, the connection portion 150 includes a plurality of third struts 131 disposed at different positions in a radial direction with the central axis Ax as a center.

Specifically, in the support device 100 shown in FIG. 4C, the connection portion 150 has a plurality of outer third struts 131A that are arranged at intervals in the circumferential direction at a third radial position Pd3 which is on a radial inner side with respect to the first radial position Pd1 described above and which is closest to the first radial position Pd1.

In the support device 100 shown in FIG. 4C, the connection portion 150 has a plurality of intermediate third struts 131B that are arranged at intervals in the circumferential direction at a fourth radial position Pd4 which is on a radial inner side with respect to the third radial position Pd3 described above and which is closest to the third radial position Pd3.

In the support device 100 shown in FIG. 4C, the connection portion 150 has a plurality of inner third struts 131C that are arranged at intervals in the circumferential direction at a fifth radial position Pd5 which is on a radial inner side with respect to the fourth radial position Pd4 described above and which is closest to the fourth radial position Pd4. The fifth radial position Pd5 is a radial position that is on a radial outer side with respect to the second radial position Pd2 described above and that is closest to the second radial position Pd2.

In the support device 100 shown in FIG. 4C, one end 132 of each of the plurality of outer third struts 131A disposed in parallel is connected to the first connection portion 151, and the other end 133 of each of the plurality of inner third struts 131C disposed in parallel is connected to the second connection portion 152.

In the support device 100 shown in FIG. 4C, the connection portion 150 has an outer third connection portion 153A to which the other ends 133 of each of the plurality of outer third struts 131A disposed in parallel and one ends 132 of each of the plurality of intermediate third struts 131B disposed in parallel are connected.

In the support device 100 shown in FIG. 4C, the connection portion 150 has an inner third connection portion 153B to which the other ends 133 of each of the plurality of intermediate third struts 131B disposed in parallel and one ends 132 of each of the plurality of inner third struts 131C disposed in parallel are connected.

In this manner, in the support device 100 according to some embodiments, since the first strut 111, the third strut 131, and the second strut 121 are connected in a zigzag shape, the displacement in the longitudinal direction, that is, the extension direction, between the steam pipe 72 and the combustion cylinder 36 can be made relatively small while allowing the displacement in the lateral direction, that is, the direction intersecting the extension direction of each of the first strut 111 and the second strut 121, between the steam pipe 72 and the combustion cylinder 36.

In the support device 100 shown in FIG. 4C, three third struts 131 including the outer third strut 131A, the intermediate third strut 131B, and the inner third strut 131C are connected in series in the connection portion 150. However, five or more odd-numbered third struts 131 may be connected in series.

### Regarding Positions of Each Connection Portion and Each End Portion Plate

In the support device 100 according to some embodiments, the second connection portion 152 may or may not overlap with the first end portion plate 101 in the axial direction with the central axis Ax as a center.

In the support device 100 according to some embodiments, the first connection portion 151 may or may not overlap with the second end portion plate 102 in the axial direction with the central axis Ax as a center.

In the support device 100 according to some embodiments, the outer third connection portion 153A may or may not overlap with the second connection portion 152 or the first end portion plate 101 in the axial direction with the central axis Ax as a center.

In the support device 100 according to some embodiments, the inner third connection portion 153B may or may not overlap with the first connection portion 151 or the second end portion plate 102 in the axial direction with the central axis Ax as a center.

In the support devices 100 shown in FIGS. 3A, 3B, 4A, 4B, and 4C, the first connection portion 151 is an annular connection portion having a first opening 151a through which the plurality of second struts 121 can pass. In the support devices 100 shown in FIGS. 3A, 3B, 4A, 4B, and 4C, each of the second struts 121 is disposed to pass through the first opening 151a of the first connection portion 151.

In this way, each of the second struts 121 that extend to the second base end portion 122 toward the pipe wall 73 by passing through the first tip portion 113 passes through the first openings 151a of the first connection portions 151 to which the plurality of first tip portions 113 are connected, so that interference between the second struts 121 and the first connection portions 151 can be prevented. In addition, in the support devices 100 shown in FIGS. 3A, 3B, 4A, 4B, and 4C, since the first connection portion 151 can be reduced in weight by providing the first opening 151a in the first connection portion 151 and the natural frequency of the support device 100 itself can be increased, it is possible to avoid resonance and prevent the support device 100 from being damaged or malfunctioning.

In the support devices 100 shown in FIGS. 3A, 3B, 4A, 4B, and 4C, the second connection portion 152 may be an annular connection portion having a second opening 152a.

Since the second connection portion 152 can be reduced in weight by providing the second opening 152a and the natural frequency of the support device 100 itself can be increased, it is possible to avoid resonance and prevent the support device 100 from being damaged or malfunctioning.

In the support device 100 shown in FIG. 4C, the inner third connection portion 153B is an annular connection portion having an opening 153Ba through which the plurality of second struts 121 can pass. In the support device 100 shown in FIG. 4C, each of the second struts 121 is disposed to pass through the opening 153Ba of the inner third connection portion 153B.

In the support device 100 shown in FIG. 4B, each of the third struts 131 is inclined with respect to the central axis Ax such that the size of the second connection portion 152 is reduced. That is, in the support device 100 shown in FIG. 4B, each of the third struts 131 is disposed to approach the central axis Ax toward the other end 133 connected to the second connection portion 152 from one end 132 connected to the first connection portion 151.

In this way, since the size of the second connection portion 152 can be reduced to reduce the weight and the natural frequency of the support device 100 itself can be increased, it is possible to avoid resonance and prevent the support device 100 from being damaged or malfunctioning.

In the support device 100 shown in FIG. 4B, in order to reduce the size of the first connection portion 151 by reducing the size of the first opening 151a of the first connection portion 151, each of the second struts 121 is disposed to come close to the central axis Ax toward the second base end portion 122 connected to the second end portion plate 102 from the second tip portion 123 connected to the second connection portion 152.

In this way, since the size of the first connection portion 151 can be reduced to reduce the weight and the natural frequency of the support device 100 itself can be increased, it is possible to avoid resonance and prevent the support device 100 from being damaged or malfunctioning.

However, in the support device 100 shown in FIG. 4B, in order to reduce the size of the second connection portion 152, each of the second struts 121 may be disposed to become farther from the central axis Ax toward the second base end portion 122 connected to the second end portion plate 102 from the second tip portion 123 connected to the second connection portion 152.

In the support device 100 shown in FIG. 4B, each of the first struts 111 is disposed to come close to the central axis Ax toward the first tip portion 113 connected to the first connection portion 151 from the first base end portion 112 connected to the first end portion plate 101.

In this way, since the size of the first connection portion 151 can be reduced to reduce the weight and the natural frequency of the support device 100 itself can be increased, it is possible to avoid resonance and prevent the support device 100 from being damaged or malfunctioning.

In the support device 100 shown in FIG. 4B, each of the first struts 111, each of the second struts 121, and each of the third struts 131 are disposed to be inclined with respect to the central axis Ax. However, in the support device 100 shown in FIG. 4B, as long as at least any one of each of the second struts 121 and each of the third struts 131 is disposed to be inclined with respect to the central axis Ax, each of the first struts 111 does not need to be inclined with respect to the central axis Ax.

Similarly, in the support device 100 shown in FIG. 4B, as long as at least any one of each of the first struts 111 and each of the third struts 131 is disposed to be inclined with respect to the central axis Ax, each of the second struts 121 does not need to be inclined with respect to the central axis Ax.

In the support device 100 shown in FIG. 4B, if at least any one of each of the first struts 111 and each of the second struts 121 is disposed to be inclined with respect to the central axis Ax, each of the third struts 131 does not need to be inclined with respect to the central axis Ax.

In the support device 100 shown in FIG. 4C, each of the first struts 111 may be disposed to be inclined with respect to the central axis Ax, and each of the second struts 121 may be disposed to be inclined with respect to the central axis Ax.

In the support device 100 shown in FIG. 4C, each of the outer third struts 131A may be disposed to be inclined with respect to the central axis Ax, each of the intermediate third struts 131B may be disposed to be inclined with respect to the central axis Ax, and each of the inner third struts 131C may be disposed to be inclined with respect to the central axis Ax.

### Regarding Radial Position of End Portion of Each Strut

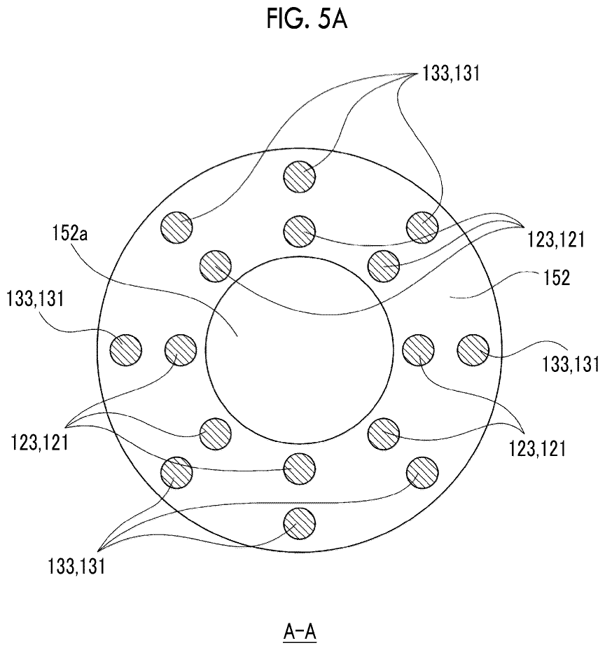

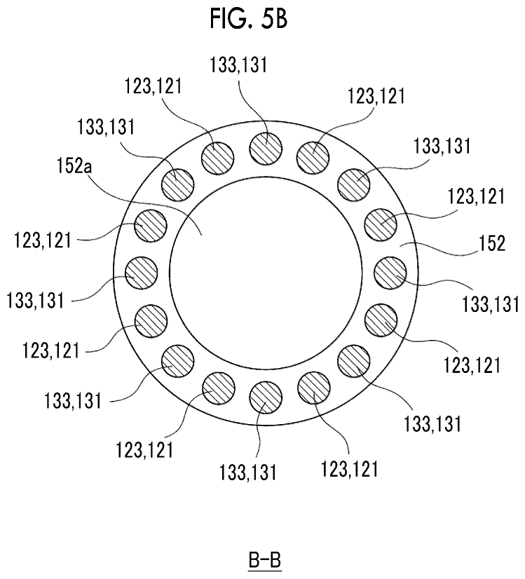

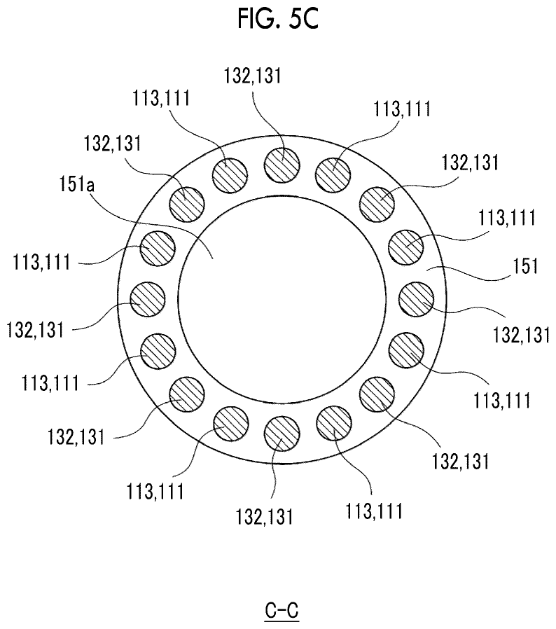

FIG. 5A is a sectional view taken along line A-A of FIG. 4A and viewed from a direction of an arrow.

FIG. 5B is a sectional view taken along line B-B of FIG. 4B and viewed from a direction of an arrow.

FIG. 5C is a sectional view taken along line C-C of FIG. 4B and viewed from a direction of an arrow.

In the support device 100 shown in FIG. 4A, as shown in FIG. 5A, each of the second tip portions 123 of the plurality of second struts 121 and each of the other ends 133 of the plurality of third struts 131 are disposed at different radial positions in the second connection portion 152.

In the support device 100 shown in FIG. 4A, similarly to the second connection portion 152, each of the first tip portions 113 of the plurality of first struts 111 and each of the one ends 132 of the plurality of third struts 131 are disposed at different radial positions in the first connection portion 151.

In the support device 100 shown in FIG. 4B, as shown in FIG. 5B, each of the second tip portions 123 of the plurality of second struts 121 and each of the other ends 133 of the plurality of third struts 131 are alternately disposed in the circumferential direction at the same radial position in the second connection portion 152.

According to the support device 100 shown in FIG. 4B, since the size of the second connection portion 152 can be reduced to reduce the weight and the natural frequency of the support device 100 itself can be increased, it is possible to avoid resonance and prevent the support device 100 from being damaged or malfunctioning.

In the support device 100 shown in FIG. 4C, similarly to the support device 100 shown in FIG. 4B, each of the second tip portions 123 of the plurality of second struts 121 and each of the other ends 133 of the plurality of inner third struts 131C may be alternately disposed in the circumferential direction at the same radial position in the second connection portion 152.

In the support device 100 shown in FIG. 4B, as shown in FIG. 5C, each of the first tip portions 113 of the plurality of first struts 111 and each of the one ends 132 of the plurality of third struts 131 are alternately disposed in the circumferential direction at the same radial position in the first connection portion 151.

According to the support device 100 shown in FIG. 4B, since the size of the first connection portion 151 can be reduced to reduce the weight and the natural frequency of the support device 100 itself can be increased, it is possible to avoid resonance and prevent the support device 100 from being damaged or malfunctioning.

In the support device 100 shown in FIG. 4A, similarly to the support device 100 shown in FIG. 4B, each of the first tip portions 113 of the plurality of first struts 111 and each of the one ends 132 of the plurality of third struts 131 may be alternately disposed in the circumferential direction at the same radial position in the first connection portion 151.

In the support device 100 shown in FIG. 4C, similarly to the support device 100 shown in FIG. 4B, each of the first tip portions 113 of the plurality of first struts 111 and each of the one ends 132 of the plurality of outer third struts 131A may be alternately disposed in the circumferential direction at the same radial position in the first connection portion 151.

In the support device 100 shown in FIG. 4C, similarly to the first connection portion 151 or the second connection portion 152 of the support device 100 shown in FIG. 4B, each of the other ends 133 of the plurality of outer third struts 131A and each of the one ends 132 of the plurality of intermediate third struts 131B may be alternately disposed in the circumferential direction at the same radial position in the outer third connection portion 153A.

In the support device 100 shown in FIG. 4C, similarly to the first connection portion 151 or the second connection portion 152 of the support device 100 shown in FIG. 4B, each of the other ends 133 of the plurality of intermediate third struts 131B and each of the one ends 132 of the plurality of inner third struts 131C may be alternately disposed in the circumferential direction at the same radial position in the inner third connection portion 153B.

The support device 100 shown in FIG. 4C includes a third connection portion 153. In the support device 100 shown in FIG. 4C, the third connection portion 153 includes an outer third connection portion 153A and an inner third connection portion 153B.

The other end 133, which is an end portion on one side of the outer third strut 131A in the extension direction, and one end 132, which is an end portion on one side of the intermediate third strut 131B in the extension direction, are connected to the outer third connection portion 153A.

The other end 133, which is an end portion on the other side of the intermediate third strut 131B in the extension direction, and one end 132, which is an end portion on the other side of the inner third strut 131C in the extension direction, are connected to the inner third connection portion 153B.

In this manner, the support device 100 shown in FIG. 4C includes the third connection portion 153 to which the end portions (one end 132 and the other end 133) of the plurality of third struts are connected. Among the plurality of third struts 131, two third struts 131 (for example, the outer third strut 131A and the intermediate third strut 131B) adjacent to each other in the radial direction with the central axis Ax as a center are connected to each other through the third connection portion 153 (the outer third connection portion 153A) at the end portions on one side of the third struts 131 (the other end 133 of the outer third strut 131A and one end 132 of the intermediate third strut 131B). Among the plurality of third struts 131, two third struts 131 (for example, the intermediate third strut 131B and the inner third strut 131C) adjacent to each other in the radial direction with the central axis Ax as a center are connected to each other through the third connection portion 153 (the inner third connection portion 153B) at the end portions on the other side (the other end 133 of the intermediate third strut 131B and one end 132 of the inner third strut 131C).

That is, the support device 100 shown in FIG. 4C includes the third connection portion 153 to which the end portions on one side or the end portions on the other side of the plurality of third struts 131 in the extension direction are connected.

According to the support device 100 shown in FIG. 4C, the plurality of third struts 131 can be connected in series in a zigzag shape via the third connection portion 153, so that the number of zigzag folds can be increased. In this way, the amount of allowance of the displacement in the lateral direction between the steam pipe 72 and the combustion cylinder 36 can be increased.

### Regarding Thicknesses of First Struts 111 and Second Struts 121

For example, as shown in FIG. 3A, in the support device 100 according to some embodiments, the first strut 111 and the second strut 121 may have a uniform thickness over the entire length thereof except for connection portions with opposing members which are connected thereto at both end portions.

In addition, for example, as shown in FIG. 3B, in the support device 100 according to some embodiments, the first strut 111 may have a thickness that is larger in a region from the first base end portion 112 to a certain axial position than in a region from the axial position to the first tip portion 113. In this way, since the natural frequency of the support device 100 itself can be increased, it is possible to avoid resonance and prevent the support device 100 from being damaged or malfunctioning.

In addition, in the support device 100 according to some embodiments, as in the first strut 111 shown in FIG. 3B, the second strut 121 may have a thickness that is larger in a region from the second base end portion 122 to a certain axial position than in a region from the axial position to the second tip portion 123. In this way, since the natural frequency of the support device 100 itself can be increased, it is possible to avoid resonance and prevent the support device 100 from being damaged or malfunctioning.

### Regarding Method for Manufacturing Support Device 100

The support device 100 according to some embodiments described above can be obtained, for example, by connecting the respective members configuring the first strut 111, the second strut 121, and the connection portion 150 by welding. In addition, the support device 100 according to some embodiments can be obtained, for example, by integrally forming the support device 100 by additive manufacturing.

That is, in the support device 100 according to some embodiments, at least one first strut 111, at least one second strut 121, and the connection portion 150 may be integrally molded by additive manufacturing.

In this way, even in a case where the support device 100 has a relatively complicated shape, the support device 100 can be relatively easily obtained.

Whether or not the support device 100 according to some embodiments is formed by additive manufacturing can be determined, for example, by looking at a cross section of the support device 100.

The method for manufacturing the support device 100 according to some embodiments is a method for manufacturing the support device 100 for supporting the combustion cylinder 36 as a second member having the cylindrical body 39 as a second wall facing a first wall with respect to the steam pipe 72 as a first member having the pipe wall 73 as the first wall.

The method for manufacturing the support device 100 according to some embodiments is a manufacturing method including integrally forming at least one first strut 111, at least one second strut 121, and the connection portion 150 having at least one third strut 131 by additive manufacturing.

In this way, even in a case where the support device 100 has a relatively complicated shape, the support device 100 can be manufactured relatively easily.

In a case where the support device 100 according to some embodiments is integrally formed by additive manufacturing, for example, the support device 100 may be formed by sequentially laminating forming layers along the central axis Ax. That is, in a case where the support device 100 according to some embodiments is integrally formed by additive manufacturing, a lamination direction may be set to the same direction as the axial direction of the central axis Ax.

In a case where the support device 100 according to some embodiments is integrally formed by additive manufacturing, an inclined surface may be provided in a portion that becomes an overhang region during the forming.

The present disclosure is not limited to the embodiments described above, and includes modified forms of the embodiments described above or forms in which these embodiments are combined as appropriate.

For example, the support device 100 according to some embodiments described above is a support device that supports the steam pipe 72 as a first member and the combustion cylinder 36 as a second member with respect to one another while allowing the relative movement between the steam pipe 72 as the first member and the combustion cylinder 36 as the second member. However, the first member and the second member are not limited to the steam pipe 72 and the combustion cylinder 36. For example, one of the first member and the second member may be a member disposed on the side of the combustion cylinder 36, such as a pipe for allowing steam for cooling to flow, and the other may be the combustion cylinder 36.

The contents described in each of the embodiments described above are understood as follows, for example.

(1) A support device 100 according to at least one embodiment of the present disclosure is a support device 100 for supporting a second member (the combustion cylinder 36 or the steam pipe 72) having a second wall (the cylindrical body 39 or the pipe wall 73) facing a first wall (the pipe wall 73 or the cylindrical body 39) with respect to a first member (the steam pipe 72 or the combustion cylinder 36) having the first wall (the pipe wall 73 or the cylindrical body 39). The support device 100 according to at least one embodiment of the present disclosure includes at least one first strut 111 that has a first base end portion 112 which is connected to the first wall (the pipe wall 73 or the cylindrical body 39), and a first tip portion 113 which is an end portion on a side opposite to the first base end portion 112, and that extends toward the second wall (the cylindrical body 39 or the pipe wall 73) from the first base end portion 112 to the first tip portion 113. The support device 100 according to at least one embodiment of the present disclosure includes at least one second strut 121 that has a second base end portion 122 which is connected to the second wall (the cylindrical body 39 or the pipe wall 73), and a second tip portion 123 which is an end portion on a side opposite to the second base end portion 122 and which is located closer to the first wall (the pipe wall 73 or the cylindrical body 39) with respect to the first tip portion 113, and that extends toward the first wall (the pipe wall 73 or the cylindrical body 39) by passing through the first tip portion 113 from the second base end portion 122 to the second tip portion 123. The support device 100 according to at least one embodiment of the present disclosure includes a connection portion 150 that has at least one third strut 131 extending in an extension direction of each of the first strut 111 and the second strut 121 in a position range between the first tip portion 113 and the second tip portion 123 in the extension direction, and that connects the first tip portion 113 of the first strut 111 and the second tip portion 123 of the second strut 121.

According to the configuration of the above (1), it is possible to absorb the displacement between the first member (the steam pipe 72 or the combustion cylinder 36) and the second member (the combustion cylinder 36 or the steam pipe 72), which is the displacement in the direction intersecting the extension direction of each of the first strut 111 and the second strut 121, while ensuring the support strength for supporting the members with respect to one another.

(2) In some embodiments, in the configuration of the above (1), the connection portion 150 may include a first connection portion 151 to which the first tip portions 113 of the plurality of first struts 111 arranged in a circumferential direction at a first radial position Pd1 around a central axis Ax along the extension direction are connected, and a second connection portion 152 to which the second tip portions 123 of the plurality of second struts 121 arranged in the circumferential direction at a second radial position Pd2 on an inner side with respect to the first radial position Pd1 are connected. The first connection portion 151 may be connected to the second connection portion 152 via the third strut 131.

According to the configuration of the above (2), since the first strut 111, the third strut 131, and the second strut 121 are connected in a zigzag shape, the displacement in the longitudinal direction, that is, the displacement in the extension direction of each the first strut 111 and the second strut 121, between the first member (the steam pipe 72 or the combustion cylinder 36) and the second member (the combustion cylinder 36 or the steam pipe 72) can be reduced to be relatively small while allowing the displacement in the lateral direction, that is, the displacement in the direction intersecting the extension direction of each the first strut 111 and the second strut 121, between the first member (the steam pipe 72 or the combustion cylinder 36) and the second member (the combustion cylinder 36 or the steam pipe 72).

(3) In some embodiments, in the configuration of the above (2), the first connection portion 151 may be an annular connection portion having a first opening 151a through which the plurality of second struts 121 are capable of passing.

According to the configuration of the above (3), each of the second struts 121 that extend toward the first wall (the pipe wall 73 or the cylindrical body 39) by passing through the first tip portion 113 to the second base end portion 122 passes through the first openings 151a of the first connection portion 151 to which the plurality of first tip portions 113 are connected, so that interference between the second struts 121 and the first connection portion 151 can be prevented.

In addition, according to the configuration of the above (3), since the first connection portion 151 can be reduced in weight by providing the first opening 151a and the natural frequency of the support device 100 itself can be increased, it is possible to avoid resonance and prevent the support device 100 from being damaged or malfunctioning.

(4) In some embodiments, in the configuration of the above (2) or (3), the second connection portion 152 may be an annular connection portion having a second opening 152a.

According to the configuration of the above (4), since the second connection portion 152 can be reduced in weight by providing the second opening 152a and the natural frequency of the support device 100 itself can be increased, it is possible to avoid resonance and prevent the support device 100 from being damaged or malfunctioning.

(5) In some embodiments, in the configuration of the above (1), the third strut 131 of the connection portion 150 may have one end 132 that is connected to the first tip portion 113, and the other end 133 that is connected to the second tip portion 123 at a position closer to the first wall (the pipe wall 73 or the cylindrical body 39) with respect to the one end 132.

According to the configuration of the above (5), the displacement in the lateral direction between the first member (the steam pipe 72 or the combustion cylinder 36) and the second member (the combustion cylinder 36 or the steam pipe 72) can be absorbed with a relatively simple configuration. In addition, according to the configuration of the above (5), since one end 132 and the other end 133, which are both end portions of the third strut 131, are connected to the first tip portion 113 of the first strut 111 and the second tip portion 123 of the second strut 121, the size of the connection portion thereof can be reduced to reduce the weight. In this way, since the natural frequency of the support device 100 itself can be increased, it is possible to avoid resonance and prevent the support device 100 from being damaged or malfunctioning.

(6) In some embodiments, in the configuration of any one of the above (2) to (4), the connection portion 150 may include a plurality of the third struts 131.

According to the configuration of the above (6), since the first strut 111, the third strut 131, and the second strut 121 are connected in a zigzag shape, even in a case where the distance between the first member (the steam pipe 72 or the combustion cylinder 36) and the second member (the combustion cylinder 36 or the steam pipe 72) is short, the displacement in the longitudinal direction, that is, the extension direction, between the first member (the steam pipe 72 or the combustion cylinder 36) and the second member (the combustion cylinder 36 or the steam pipe 72) can be suppressed while allowing the displacement in the lateral direction, that is, the direction intersecting the extension direction of each of the first strut 111 and the second strut 121, between the first member (the steam pipe 72 or the combustion cylinder 36) and the second member (the combustion cylinder 36 or the steam pipe 72).

(7) In some embodiments, in the configuration of the above (6), each of the plurality of third struts 131 may have one end 132 that is connected to the first connection portion 151, and the other end 133 that is connected to the second connection portion 152 at a position closer to the first wall (the pipe wall 73 or the cylindrical body 39) with respect to the one end 132. The plurality of third struts 131 may be inclined with respect to the central axis Ax such that the size of the second connection portion 152 is reduced.

According to the configuration of the above (7), since the size of the second connection portion 152 can be reduced to reduce the weight and the natural frequency of the support device 100 itself can be increased, it is possible to avoid resonance and prevent the support device 100 from being damaged or malfunctioning.

(8) In some embodiments, in the configuration of the above (7), each of the second tip portions 123 of the plurality of second struts 121 and each of the other ends 133 of the plurality of third struts 131 may be alternately disposed in the circumferential direction at the same radial position in the second connection portion 152.

According to the configuration of the above (8), since the size of the second connection portion 152 can be reduced to reduce the weight and the natural frequency of the support device 100 itself can be increased, it is possible to avoid resonance and prevent the support device 100 from being damaged or malfunctioning.

(9) In some embodiments, in the configuration of the above (7) or (8), each of the first tip portions 113 of the plurality of first struts 111 and each of the one ends 132 of the plurality of third struts 131 may be alternately disposed in the circumferential direction at the same radial position in the first connection portion 151.

According to the configuration of the above (9), since the size of the first connection portion 151 can be reduced to reduce the weight and the natural frequency of the support device 100 itself can be increased, it is possible to avoid resonance and prevent the support device 100 from being damaged or malfunctioning.

(10) In some embodiments, the configuration of the above (2) may further include a third connection portion 153 to which end portions of a plurality of the third struts 131 are connected. Among the plurality of third struts 131, in two third struts 131 adjacent to each other in a radial direction with the central axis Ax as a center, end portions (one end 132 or the other end 133) on one side of the third struts 131 or end portions on the other side (one end 132 or the other end 133) of the third struts 131 may be connected to each other via the third connection portion 153.

According to the configuration of the above (10), since the plurality of third struts 131 can be connected in series in a zigzag shape via the third connection portion 153, the number of zigzag folds can be increased. In this way, the amount of allowance of the displacement in the lateral direction between the first member (the steam pipe 72 or the combustion cylinder 36) and the second member (the combustion cylinder 36 or the steam pipe 72) can be increased.

(11) In some embodiments, in the configuration of the above (9), the plurality of first struts 111, the plurality of second struts 121, and the plurality of third struts 131 may be arranged in groups of three or more in the circumferential direction centered on the central axis Ax along the extension direction.

According to the configuration of the above (11), it is possible to suppress a decrease in the rigidity of the support device 100 in a specific direction in the lateral direction when the first member (the steam pipe 72 or the combustion cylinder 36) and the second member (the combustion cylinder 36 or the steam pipe 72) are displaced in the lateral direction.

(12) In some embodiments, the configuration of the above (11) may further include a first end portion plate 101 to which the first base end portions 112 of the plurality of first struts 111 arranged in the circumferential direction centered on the central axis Ax along the extension direction are connected. The first base end portion 112 may be connected to the first wall (the pipe wall 73 or the cylindrical body 39) via the first end portion plate 101.

According to the configuration of the above (12), the support device 100 is easily connected to the first wall (the pipe wall 73 or the cylindrical body 39) as compared with a case where each of the first base end portions 112 of the plurality of first struts 111 is directly connected to the first wall (the pipe wall 73 or the cylindrical body 39).

(13) In some embodiments, the configuration of the above (12) may further include a second end portion plate 102 to which the second base end portions 122 of the plurality of second struts 121 arranged in the circumferential direction centered on the central axis Ax along the extension direction are connected. The second base end portion 122 may be connected to the second wall (the cylindrical body 39 or the pipe wall 73) via the second end portion plate 102.

According to the configuration of the above (13), the support device 100 is easily connected to the second wall (the cylindrical body 39 or the pipe wall 73) as compared with a case where each of the second base end portions 122 of the plurality of second struts 121 is directly connected to the second wall (the cylindrical body 39 or the pipe wall 73).

(14) In some embodiments, in the configuration of the above (13), the at least one first strut 111, the at least one second strut 121, and the connection portion 150 may be integrally molded by additive manufacturing.

According to the configuration of the above (14), even in a case where the support device 100 has a relatively complicated shape, the support device 100 can be relatively easily obtained.

(15) The method for manufacturing the support device 100 according to at least one embodiment of the present disclosure is a method for manufacturing the support device 100 for supporting a second member (the combustion cylinder 36 or the steam pipe 72) having a second wall (the cylindrical body 39 or the pipe wall 73) facing a first wall (the pipe wall 73 or the cylindrical body 39) with respect to a first member (the steam pipe 72 or the combustion cylinder 36) having the first wall (the pipe wall 73 or the cylindrical body 39). In the method for manufacturing a support device 100 according to at least one embodiment of the present disclosure, at least one first strut 111, at least one second strut 121, and the connection portion 150 are integrally formed by additive manufacturing. Here, at least one first strut 111 has a first base end portion 112 that is connected to the first wall (the pipe wall 73 or the cylindrical body 39), and a first tip portion 113 which is an end portion on a side opposite to the first base end portion 112, and extends toward the second wall (the cylindrical body 39 or the pipe wall 73) from the first base end portion 112. At least one second strut 121 has a second base end portion 122 that is connected to the second wall (the cylindrical body 39 or the pipe wall 73), and a second tip portion 123 which is an end portion on a side opposite to the second base end portion 122 and which is located closer to the first wall (the pipe wall 73 or the cylindrical body 39) with respect to the first tip portion 113, and extends toward the first wall (the pipe wall 73 or the cylindrical body 39) by passing through the first tip portion 113 from the second base end portion 122 to the second tip portion 123. The connection portion 150 has at least one third strut 131 that extends along an extension direction of each of the first strut 111 and the second strut 121 in a position range between the first tip portion 113 and the second tip portion 123 in the extension direction, and connects the first tip portion 113 of the first strut 111 and the second tip portion 123 of the second strut 121.

According to the method of the above (15), even in a case where the support device 100 has a relatively complicated shape, the support device 100 can be manufactured relatively easily.

### REFERENCE SIGNS LIST

1: gas turbine
36: combustion cylinder
39: cylindrical body
72: steam pipe
73: pipe wall
100: support device
101: first end portion plate
102: second end portion plate
111: first strut
112: first base end portion
113: first tip portion
121: second strut
122: second base end portion
123: third tip portion
131: third strut
132: one end
133: other end
150: connection portion
151: first connection portion
151a: first opening
152: second connection portion
152a: second opening
153: third connection portion

1. A support device for supporting a second member having a second wall facing a first wall with respect to a first member having the first wall, the support device comprising:
at least one first strut that has a first base end portion which is connected to the first wall, and a first tip portion which is an end portion on a side opposite to the first base end portion, and that extends toward the second wall from the first base end portion to the first tip portion;
at least one second strut that has a second base end portion which is connected to the second wall, and a second tip portion which is an end portion on a side opposite to the second base end portion and which is located closer to the first wall with respect to the first tip portion, and that extends toward the first wall by passing through the first tip portion from the second base end portion to the second tip portion; and
a connection portion that has at least one third strut extending along an extension direction of each of the first strut and the second strut in a position range between the first tip portion and the second tip portion in the extension direction, and that connects the first tip portion of the first strut and the second tip portion of the second strut.

2. The support device according to claim 1,
wherein the connection portion includes:
a first connection portion to which the first tip portions of a plurality of the first struts arranged in a circumferential direction at a first radial position around a central axis along the extension direction are connected; and
a second connection portion to which the second tip portions of a plurality of the second struts arranged in the circumferential direction at a second radial position on an inner side with respect to the first radial position are connected, and
the first connection portion is connected to the second connection portion via the third strut.

3. The support device according to claim 2,
wherein the first connection portion is an annular connection portion having a first opening through which the plurality of second struts are capable of passing.

4. The support device according to claim 2,
wherein the second connection portion is an annular connection portion having a second opening.

5. The support device according to claim 1,
wherein the third strut of the connection portion has one end that is connected to the first tip portion, and the other end that is connected to the second tip portion at a position closer to the first wall with respect to the one end.

6. The support device according to claim 2,
wherein the connection portion includes a plurality of the third struts.

7. The support device according to claim 6,
wherein each of the plurality of third struts has one end that is connected to the first connection portion, and the other end that is connected to the second connection portion at a position closer to the first wall with respect to the one end, and
the plurality of third struts are inclined with respect to the central axis such that a size of the second connection portion is reduced.

8. The support device according to claim 7,
wherein each of the second tip portions of the plurality of second struts and each of the other ends of the plurality of third struts are alternately disposed in the circumferential direction at the same radial position in the second connection portion.

9. The support device according to claim 7,
wherein each of the first tip portions of the plurality of first struts and each of the one ends of the plurality of third struts are alternately disposed in the circumferential direction at the same radial position in the first connection portion.

10. The support device according to claim 2, further comprising:
a third connection portion to which end portions of a plurality of the third struts are connected,
wherein among the plurality of third struts, in two third struts adjacent to each other in a radial direction with the central axis as a center, end portions on one side of the third struts or end portions on the other side of the third struts are connected to each other via the third connection portion.

11. The support device according to claim 9,
wherein the plurality of first struts, the plurality of second struts, and the plurality of third struts are arranged in groups of three or more in the circumferential direction centered on the central axis along the extension direction.

12. The support device according to claim 11, further comprising:
a first end portion plate to which the first base end portions of the plurality of first struts arranged in the circumferential direction centered on the central axis along the extension direction are connected,
wherein the first base end portion is connected to the first wall via the first end portion plate.

13. The support device according to claim 12, further comprising:
a second end portion plate to which the second base end portions of the plurality of second struts arranged in the circumferential direction centered on the central axis along the extension direction are connected,
wherein the second base end portion is connected to the second wall via the second end portion plate.

14. The support device according to claim 13,
wherein the at least one first strut, the at least one second strut, and the connection portion are integrally molded by additive manufacturing.

15. A method for manufacturing a support device for supporting a second member having a second wall facing a first wall with respect to a first member having the first wall, the method comprising:
integrally molding, by additive manufacturing,
at least one first strut that has a first base end portion which is connected to the first wall, and a first tip portion which is an end portion on a side opposite to the first base end portion, and that extends toward the second wall from the first base end portion to the first tip portion;
at least one second strut that has a second base end portion which is connected to the second wall, and a second tip portion which is an end portion on a side opposite to the second base end portion and which is located closer to the first wall with respect to the first tip portion, and that extends toward the first wall by passing through the first tip portion from the second base end portion to the second tip portion; and
a connection portion that has at least one third strut extending along an extension direction of each of the first strut and the second strut in a position range between the first tip portion and the second tip portion in the extension direction, and that connects the first tip portion of the first strut and the second tip portion of the second strut.
